(19) United States
(12) Patent Application Publication
(10) Pub. No.: US 2015/0122622 A1
(43) Pub. Date: May 7, 2015

(54) KEYBOARD DEVICE AND KEY FABRICATING METHOD FOR KEYBOARD DEVICE

(71) Applicant: Primax Electronics Ltd., Taipei (TW)

(72) Inventor: XIANG-HUI DENG, Taipei (TW)

(73) Assignee: Primax Electronics Ltd., Taipei (TW)

(21) Appl. No.: 14/103,277

(22) Filed: Dec. 11, 2013

(30) Foreign Application Priority Data
Nov. 6, 2013 (CN) 201310545444.9

(51) Int. Cl. H01H 13/705

(52) U.S. Cl. CPC H01H 13/705; H01H 2233/00
USPC 200/5 A; 264/255

(57) ABSTRACT

A keyboard device includes an upper cover, an elastic key plate, a switch module, and a base plate. The upper cover includes plural openings. The elastic key plate is disposed on an inner surface of the upper cover. The elastic key plate includes plural elastic keys. The plural elastic keys are inserted into the plural openings of the upper cover and exposed outside the upper cover. The elastic key plate is integrally formed with the upper cover. There are no gaps between the plural elastic keys and the openings of the upper cover. Since dust or foreign liquid cannot be introduced into the inner portion of the keyboard device, the inner circuitries of the keyboard device will not be damaged by the dust or the foreign liquid.

### FIELD OF THE INVENTION

The present invention relates to a peripheral input device of a computer, and more particularly to a keyboard device.

### BACKGROUND OF THE INVENTION

Generally, the widely-used peripheral input device of a computer includes for example a mouse device, a keyboard device, a trackball device, or the like. Via the keyboard device, the user may input characters and symbols into the computer directly. As a consequence, most users and most manufacturers of the input devices pay much attention to the keyboard devices.

FIG. 1 is a schematic top view illustrating the outer appearance of a conventional keyboard device. As shown in FIG. 1, plural keys 10 are installed on a surface of the conventional keyboard device 1. These keys 10 are classified into some types, e.g. ordinary keys, numeric keys and function keys. When one of these keys 10 is depressed by the user's fingers, a corresponding electronic signal is issued to the computer, and thus the computer executes a function corresponding to the depressed key. For example, when an ordinary key is depressed, a corresponding English letter or symbol is inputted into the computer. When a numeric key is depressed, a corresponding number is inputted into the computer. In addition, the function keys (F1˜F12) can be programmed to cause corresponding application programs to provide certain functions. For example, the conventional keyboard device 1 is a keyboard device for a notebook computer.

Hereinafter, the inner structure of the conventional keyboard device 1 will be illustrated in more details. FIG. 2 is a schematic cross-sectional view illustrating the conventional keyboard device. As shown in FIG. 2, the conventional keyboard device 1 comprises plural keys 10, a membrane switch circuit member 11, a supporting plate 12, an upper cover 13, and a base plate 14. Each of the plural key 10 comprises a keycap 101, a scissors-type connecting element 102 and an elastic element 103. From top to bottom, the keycap 101, the scissors-type connecting element 102, the elastic element 103, the membrane switch circuit member 11, the supporting plate 12 and the base plate 14 of the conventional keyboard device 1 are sequentially shown. The upper cover 13 is located at a side of the scissors-type connecting element 102. The elastic element 103 is a rubbery elastomer.

The upper cover 13 comprises plural openings 131. The plural scissors-type connecting elements 102 are penetrated through the openings 131, respectively. In the key 10, the keycap 101 is exposed outside the conventional keyboard device 1, so that the keycap 101 can be depressed by the user. The scissors-type connecting element 102 is used for connecting the keycap 101 and the supporting plate 12. The elastic element 103 is penetrated through the scissors-type connecting element 102. In addition, both ends of the elastic element 103 are contacted with the keycap 101 and the membrane switch circuit member 11, respectively. The membrane switch circuit member 11 comprises an upper wiring board 111, a spacer layer 112, and a lower wiring board 113. The upper wiring board 111, the spacer layer 112 and the lower wiring board 113 are all made of a light-transmissible material. The light-transmissible material is for example polycarbonate (PC) or polyethylene (PE). The upper wiring board 111 has plural upper contacts 1111. The spacer layer 112 is disposed under the upper wiring board 111, and comprises plural perforations 1121 corresponding to the plural upper contacts 1111. The lower wiring board 113 is disposed under the spacer layer 112, and comprises plural lower contacts 1131 corresponding to the plural upper contacts 1111. The plural lower contacts 1131 and the plural upper contacts 1111 are collectively defined as plural key switches 114. The base plate 14 is disposed under the supporting plate 12 for supporting the plural keys 10, the membrane switch circuit member 11 and the supporting plate 12.

When one of the keycaps 101 is depressed by the user, in response to the depressing force provided by the user, the keycap 101 is moved downwardly to compress the elastic element 103. At the same time, the scissors-type connecting element 102 is correspondingly swung. Consequently, the elastic element 101 is subject to deformation to press the corresponding upper contact 1111 of the membrane switch circuit member 11, and the upper contact 1111 is contacted with the corresponding lower contact 1131. Under this circumstance, the key switch 114 is triggered to generate a corresponding key signal. When the depressing force exerted on the keycap 101 is eliminated, the elastic element 103 is restored to its original shape in response to the elasticity of the elastic element 103, and the upper contact 1111 is no longer pressed. As the elastic element 103 is restored to its original shape, the keycap 101 is moved upwardly in response to a restoring force provided by the elastic element 103. The scissors-type connecting element 102 is swung with the keycap 101 until the keycap 101 is moved to its original position where the keycap 101 is not depressed.

Generally, during the process of operating the conventional keyboard device 1, the keycap 101 has to be moved upwardly or downwardly relative to the supporting plate 12. Consequently, it is necessary to install the plural openings 131 corresponding to the plural keys 10. Due to the plural openings 131, the keycaps 101 can be moved upwardly or downwardly, and the scissors-type connecting elements 102 can be accommodated within the plural openings 131. However, since the upper cover 13 has the plural openings 131, there are plural gaps G between the keycaps 101 and the upper cover 13. Consequently, dust or foreign liquid (e.g. the beverage of the user) is easily introduced into the inner portion of the conventional keyboard device 1 through the plural gaps G. If the dust or foreign liquid is introduced into the internal portion of the conventional keyboard device 1, the membrane switch circuit member 11 or other inner circuitries are possibly damaged.

Moreover, since the keycap 101 and the corresponding scissors-type connecting element 102 are coupled with each other through engagement, the keycap 101 is easily detached from the conventional keyboard device 1 by children or babies. During the process of detaching the keycap 101, the keycap 101 or the scissors-type connecting element 102 may be suffered from damage. If the keycap 101 or the scissors-type connecting element 102 is damaged, the keycap 101 cannot be assembled into the conventional keyboard device 1 again.

Therefore, there is a need of providing an improved keyboard device for reducing the possibility of detaching the keycap and avoiding the entrance of dust or foreign liquid.

### SUMMARY OF THE INVENTION

An object of the present invention provides a keyboard device for reducing the possibility of detaching the keycap thereof.

Another object of the present invention provides a keyboard device for avoiding the entrance of dust or foreign liquid.

A further object of the present invention provides a key fabricating method for fabricating a keyboard device with the above functions.

In accordance with an aspect of the present invention, there is provided a keyboard device. The keyboard device includes an upper cover, an elastic key plate, a switch module, and a base plate. The upper cover includes plural openings. The elastic key plate is disposed on an inner surface of the upper cover. The elastic key plate includes plural elastic keys. The plural elastic keys are inserted into the plural openings of the upper cover and exposed outside the upper cover. The elastic key plate is integrally formed with the upper cover. There are no gaps between the plural elastic keys and the openings of the upper cover. The switch module is disposed under the elastic key plate. When the switch module is triggered by one of the plural elastic keys, the switch module generates a corresponding key signal. The base plate is disposed under the switch module and supports the switch module.

In accordance with another aspect of the present invention, there is provided a key fabricating method for a keyboard device. The key fabricating method includes the following steps. Firstly, a male mold is combined with a first female mold to define a first space between the male mold and the first female mold. Then, a first material is charged into a first charging hole of the first female mold to form an upper cover in the first space. Then, the male mold is detached from the first female mold, and the upper cover is retained in the male mold. Then, the male mold is combined with a second female mold to define a second space between the male mold and the second female mold and dispose the upper cover within the second space. Afterwards, a second material is charged into a second charging hole of the second female mold to form an integral structure of the upper cover and an elastic key plate in the second space and form plural elastic keys on the elastic key plate.

The key fabricating method of the present invention uses a double-colored injection process to produce the integral structure of the upper cover and the elastic key plate of the keyboard device of the present invention. Consequently, there are no gaps between the plural elastic keys and the plural openings of the upper cover. Under this circumstance, since the dust or the foreign liquid cannot be introduced into the inner portion of the keyboard device, the inner circuitries of the keyboard device will not be damaged by the dust or the foreign liquid. Moreover, since the elastic key plate and the upper cover are integrally formed with each other, it is difficult to detach the elastic keys from the keyboard device. In other words, the design of the keyboard device of the present invention can prevent the detached keys from being eaten by children or babies. On the other hand, since the elastic key is elastic and deformable, the scissors-type connecting elements and the elastic elements of the conventional keyboard device are no longer included in the keyboard device of the present invention. Consequently, the number of components is reduced, the reliability is enhanced, and the material cost is reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard device;

FIG. 2 is a schematic cross-sectional view illustrating the conventional keyboard device;

FIG. 3 is a schematic exploded view illustrating a keyboard device according to a first embodiment of the present invention;

FIG. 4 is a schematic exploded view illustrating the upper cover and the elastic key plate of the keyboard device according to the first embodiment of the present invention;

FIG. 5 is a schematic assembled view illustrating the upper cover and the elastic key plate of the keyboard device according to the first embodiment of the present invention and taken along another viewpoint;

FIG. 6 is a schematic perspective view illustrating the outer appearance of the keyboard device according to the first embodiment of the present invention;

FIG. 7 is a schematic perspective view illustrating the outer appearance of a male mold for fabricating the keyboard device according to the first embodiment of the present invention;

FIG. 8 is a schematic perspective view illustrating the outer appearance of a first female mold for fabricating the keyboard device according to the first embodiment of the present invention;

FIG. 9 is a schematic perspective view illustrating the outer appearance of a second female mold for fabricating the keyboard device according to the first embodiment of the present invention;

FIGS. 10A and 10B are flowcharts illustrating a key fabricating method for the keyboard device according to the first embodiment of the present invention;

FIG. 11 is a schematic perspective view illustrating the outer appearance of the upper cover and the male mold for fabricating the keyboard device according to the first embodiment of the present invention;

FIG. 12 is a schematic perspective view illustrating the outer appearance of the upper cover, the elastic key plate and the male mold for fabricating the keyboard device according to the first embodiment of the present invention; and

FIG. 13 is a schematic exploded view illustrating a keyboard device according to a second embodiment of the present invention.

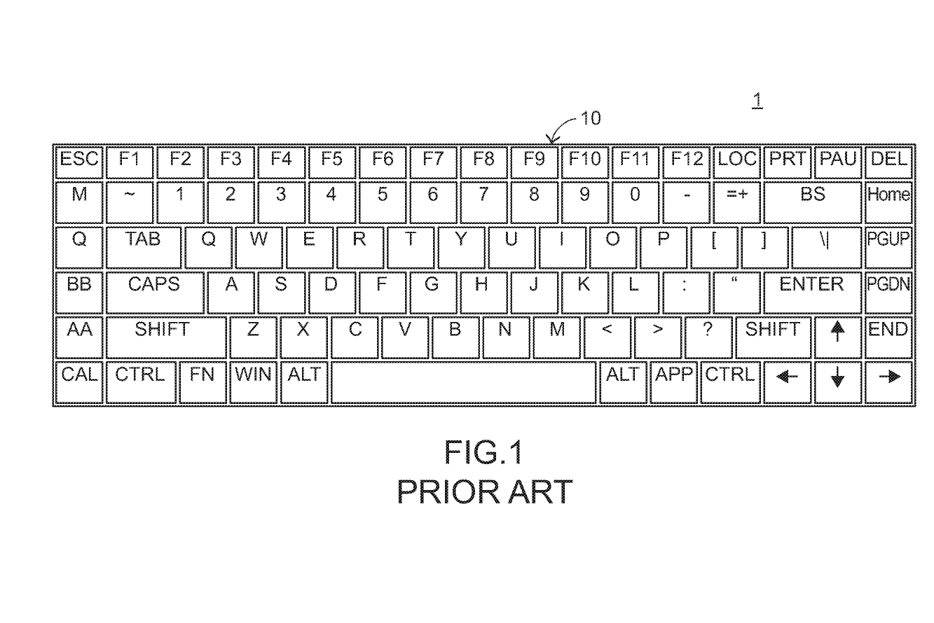

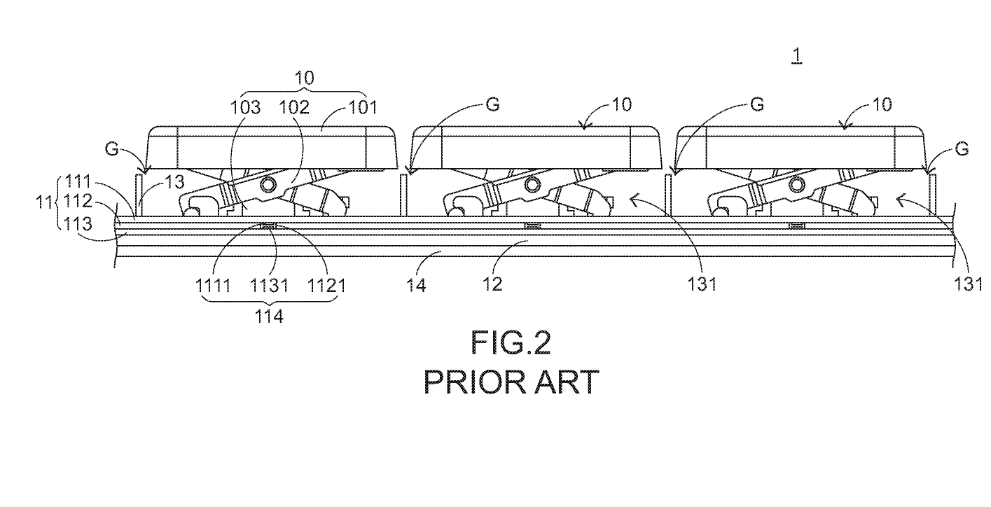

### DETAILED DESCRIPTION OF THE PREFERRED EMBODIMENT

For obviating the drawbacks encountered from the prior art, the present invention provides a keyboard device.

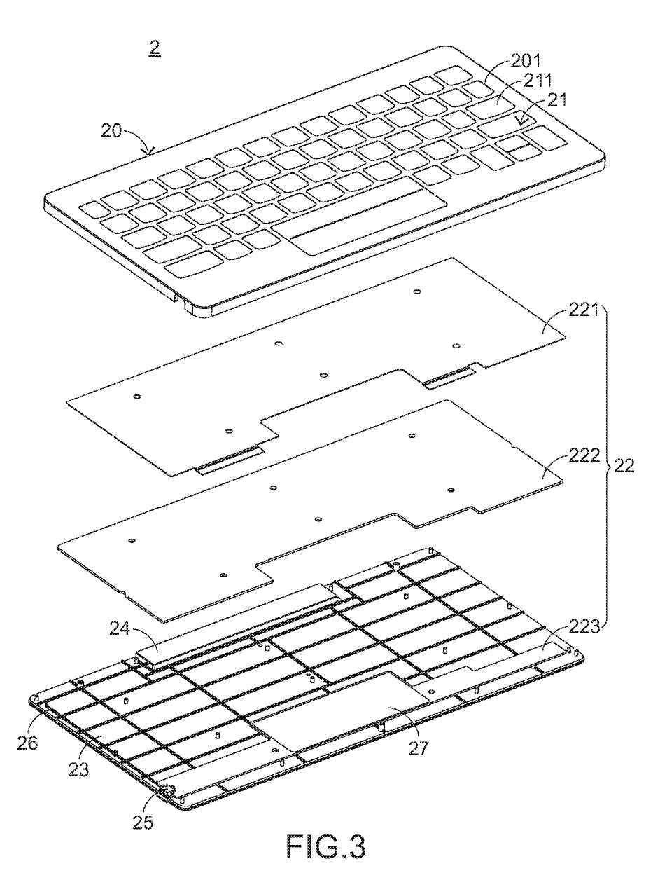

FIG. 3 is a schematic exploded view illustrating a keyboard device according to a first embodiment of the present invention. As shown in FIG. 3, the keyboard device 2 comprises an upper cover 20, an elastic key plate 21, a switch module 22, a base plate 23, a rechargeable battery 24, a connecting port 25, an inner wiring part 26, and a touch module 27. The switch module 22 is disposed under the elastic key plate 21. When the switch module 22 is triggered by the elastic key plate 21, a corresponding key signal is generated. The switch module 22 comprises a membrane switch circuit member 221, a supporting plate 222, and a circuit board 223. The membrane switch circuit member 221 is disposed under the elastic key plate 21. In addition, the membrane switch circuit member 221 is not contacted with the elastic key plate 21. When the membrane switch circuit member 221 is triggered by the elastic key plate 21, the corresponding key signal is generated. The structure and operating principle of the membrane switch circuit member 221 are similar to those of the membrane switch circuit member 11 of the conventional keyboard 1, and are not redundantly described herein. The supporting plate 222 is arranged between the membrane switch circuit member 221 and the base plate 23. The supporting plate 222 is used for supporting the membrane switch circuit member 221 and allowing the membrane switch circuit member 221 to be kept flat. The circuit board 223 is connected with the membrane switch circuit member 221 in order to output the key signal. In this embodiment, the circuit board 223 is a printed circuit board (PCB).

Please refer to FIG. 3 again. The base plate 23 is disposed under the switch module 22 for supporting the switch module 22. The rechargeable battery 24 is disposed on the base plate 23 and connected with the switch module 22. The rechargeable battery 24 is used for providing electric power to the switch module 22, thereby powering the switch module 22. The connecting port 25 is fixed on the circuit board 223, and electrically connected with the circuit board 223. Through the inner wiring part 26 which is connected with the circuit board 223, the connecting port 25 is connected with the rechargeable battery 24. When a first terminal of an external wire (not shown) is plugged into the connecting port 25 and a second terminal of the external wire is connected with a power source (not shown), the power source provides external electric power to the keyboard device 2. In addition, the external electric power is transmitted to the rechargeable battery 24 through the connecting port 25 and the inner wiring part 26 in order to charge the rechargeable battery 24. The touch module 27 is disposed on the circuit board 223 and electrically connected with the circuit board 223. The touch module 27 is used for detecting a motion of a user's finger, and generates a displacement signal corresponding to the motion of the user's finger. According to the displacement signal, a cursor of a computer system (not shown) in communication with the keyboard device 2 is correspondingly moved. In this embodiment, the base plate 23 is made of a plastic material, and the connecting port 25 is a mini universal serial bus (Mini USB). Alternatively, in some other embodiment, the base plate is made of a metallic material, and the connecting port is a universal serial bus (USB).

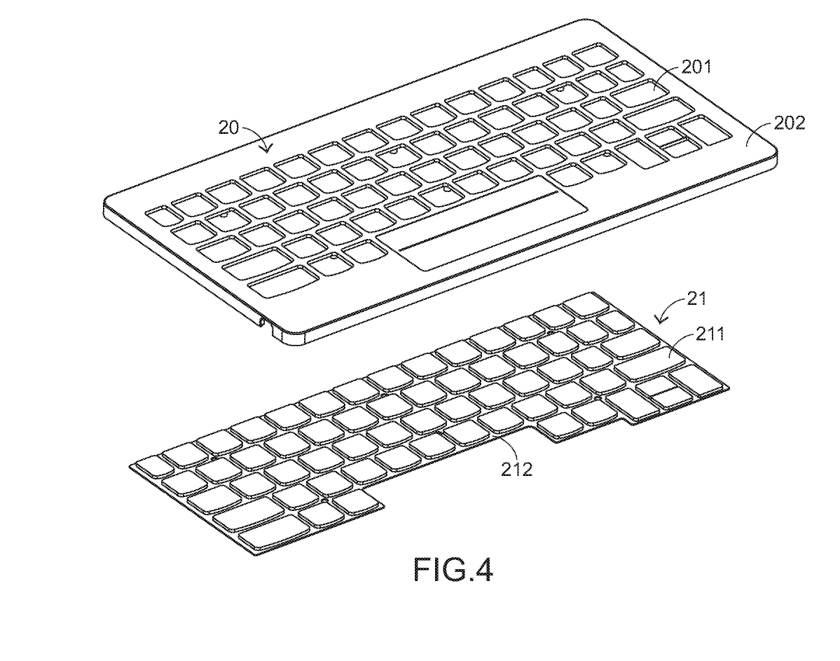

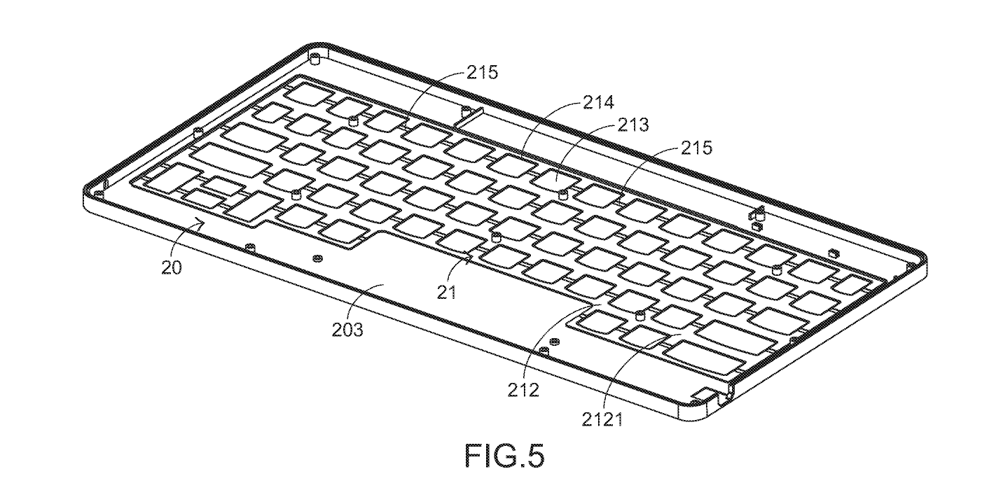

Hereinafter, the structures of the upper cover 20 and the elastic key plate 21 will be illustrated with reference to FIGS. 3, 4 and 5. FIG. 4 is a schematic exploded view illustrating the upper cover and the elastic key plate of the keyboard device according to the first embodiment of the present invention. FIG. 5 is a schematic assembled view illustrating the upper cover and the elastic key plate of the keyboard device according to the first embodiment of the present invention and taken along another viewpoint. As shown in FIG. 3, the elastic key plate 21 is coupled to the upper cover 20. The elastic key plate 21 is produced by the key fabricating method of the present invention. In particular, the elastic key plate 21 is integrally formed with the upper cover 20. The process of producing the elastic key plate 21 and the upper cover 20 will be illustrated in more details later. For clearly interpreting the structures of the upper cover 20 and the elastic key plate 21, the upper cover 20 and the elastic key plate 21 shown in FIG. 4 are separated from each other. The upper cover 20 comprises plural openings 201. In addition, the plural openings 201 run through an outer surface 202 and an inner surface 203 of the upper cover 20. As shown in FIG. 5, the elastic key plate 21 is disposed on the inner surface 203 of the upper cover 20. The elastic key plate 21 comprises plural elastic keys 211, a plate body 212, plural triggering parts 213, plural recesses 214, and plural air vents 215. The plural elastic keys 211 are inserted into the plural openings 201, and exposed outside the upper cover 20. Consequently, the user may depress the plural elastic keys 211 to trigger the membrane switch circuit member 221. The plate body 212 is used for supporting the plural elastic keys 211.

Please refer to FIGS. 3, 4 and 5. The plural triggering parts 213 are aligned with the plural elastic keys 211, respectively. In addition, the plural triggering parts 213 are disposed on bottom surfaces of the plural elastic keys 211, respectively. When one of the plural elastic keys 211 is depressed, the corresponding elastic key 211 is subject to deformation and contacted with the membrane switch circuit member 221 in order to trigger the membrane switch circuit member 221. The plural recesses 214 are aligned with the plural elastic keys 211, respectively. In addition, each of the plural recesses 214 is arranged around the corresponding triggering part 213, and arranged between the plate body 212 and the corresponding triggering part 213. Moreover, the plural triggering parts 213 are separated from each other by the plural recesses 214. Consequently, if a specified triggering part 213 is depressed and subjected to deformation, the triggering parts 213 adjacent to the specified triggering part 213 are not driven by the specified triggering part 213. Under this circumstance, the membrane switch circuit member will not be erroneously triggered. The plural air vents 215 are formed in a bottom surface 2121 of the plate body 212, and located beside the plural elastic keys 211. The plural air vents 215 and the plural elastic keys 211 are not in a one-to-one correspondence. In particular, as shown in FIG. 5, the number of the plural air vents 215 is larger than the number of the plural elastic keys 211. When one of the plural elastic keys 211 is depressed by the user and the switch module 22 is triggered by the corresponding triggering part 213, the air between the triggering part 213 and the membrane switch circuit member 221 can be vented through the corresponding air vents 215. Consequently, the triggering part 213 will not be adsorbed by the membrane switch circuit member 221, and the triggering part 213 can be restored to its original shape.

In this embodiment, the plural triggering parts 213 are disposed on the bottom surfaces of the plural elastic keys 211, respectively, and the plural elastic keys 211 and the plural triggering parts 213 are integrally formed with the plate body 212. The upper cover 20 and the elastic key plate 21 are produced by a double-colored injection process. In addition, the upper cover 20 and the elastic key plate 21 are integrally formed with each other. The upper cover 20 is made of polycarbonate (PC) or acrylonitrile butadiene styrene (ABS), but is not limited thereto. The elastic key plate 21 is made of thermoplastic elastomer (TPE), but is not limited thereto. Alternatively, in some other embodiments, the plural triggering parts are raised structures on the bottom surfaces of the plural elastic keys in order to facilitate triggering the membrane switch circuit member.

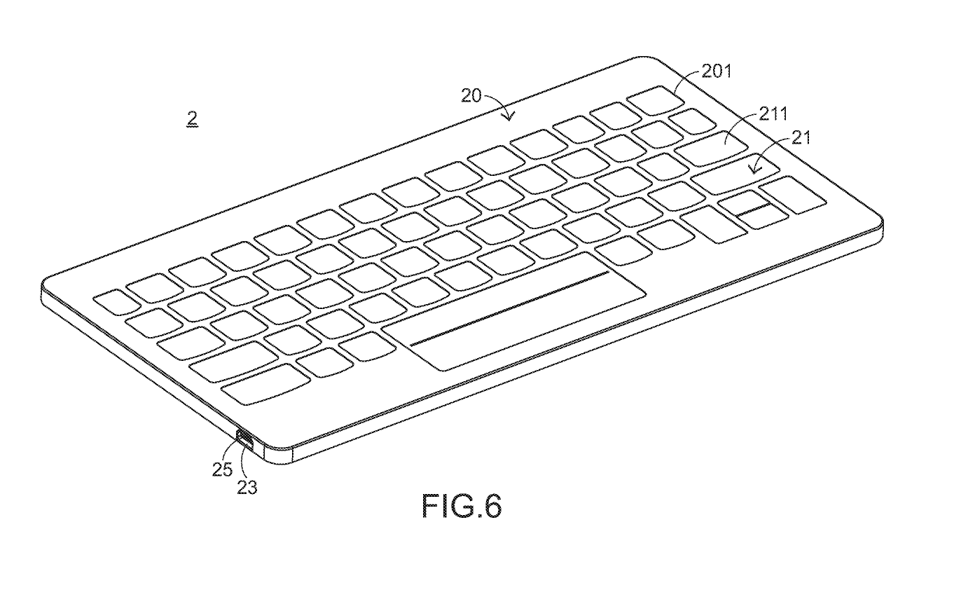

FIG. 6 is a schematic perspective view illustrating the outer appearance of the keyboard device according to the first embodiment of the present invention. After the upper cover 20, the elastic key plate 21, the switch module 22, the base plate 23, the rechargeable battery 24, the connecting port 25, the inner wiring part 26 and the touch module 27 are assembled, the resulting structure of the keyboard device is shown in FIG. 6. Since the elastic key plate 21 is integrally formed with the upper cover 20, after the plural elastic keys 211 are inserted into the plural openings 201, there is no gap between each elastic key 211 and the corresponding opening 201 of the upper cover 20. Under this circumstance, since the dust outside the keyboard device 2 or the foreign liquid cannot be introduced into the inner portion of the keyboard device 2, the inner circuitries of the keyboard device 2 can be effectively protected.

The operations of the components of the keyboard device 2 in response to the depressing action of the elastic key 211 will be illustrated with reference to FIGS. 3, 4 and 5. When one of the plural elastic keys 211 is depressed, the depressed elastic key 211 and the corresponding triggering part 213 are subject to deformation in response to the depressing force provided by the user, and the triggering part 213 is contacted with the membrane switch circuit member 221. Under this circumstance, the membrane switch circuit member 221 is triggered to generate the corresponding key signal. Meanwhile, in response to deformation of the triggering part 213, the air between the triggering part 213 and the membrane switch circuit member 221 is vented by the corresponding air vents 215. Consequently, the triggering part 213 will not be adsorbed by the membrane switch circuit member 221. When the elastic key 211 is no longer depressed by the user, the elastic key 211 and the corresponding triggering part 213 are restored to their original shapes and returned to their original positions where they are not depressed. Moreover, the user's finger may be placed on a region of the upper cover 20 corresponding to the touch module 27. As the user's finger is moved on this region, the cursor of the computer system is correspondingly moved.

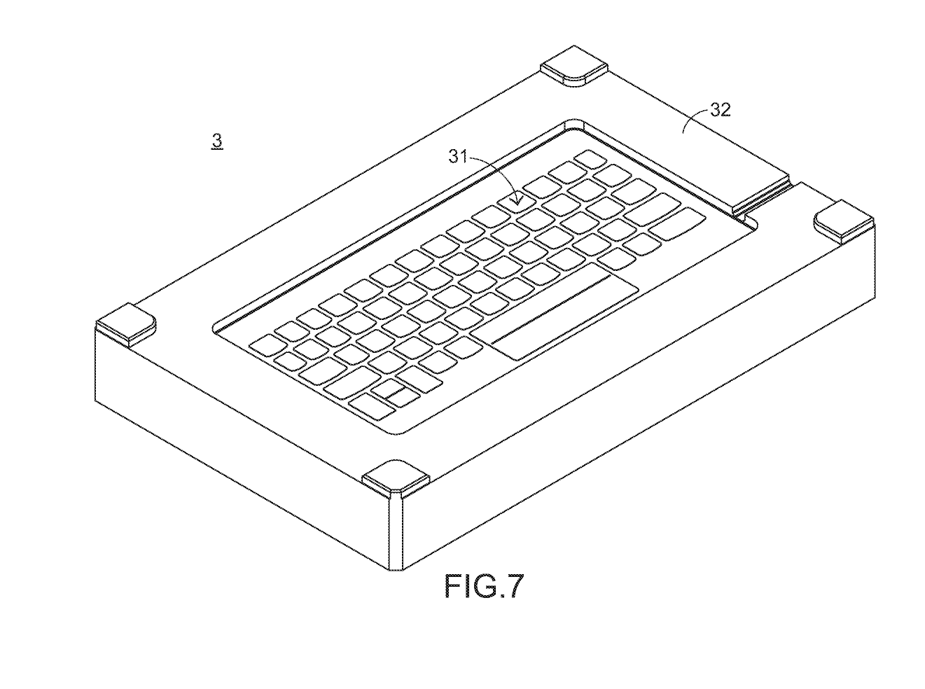

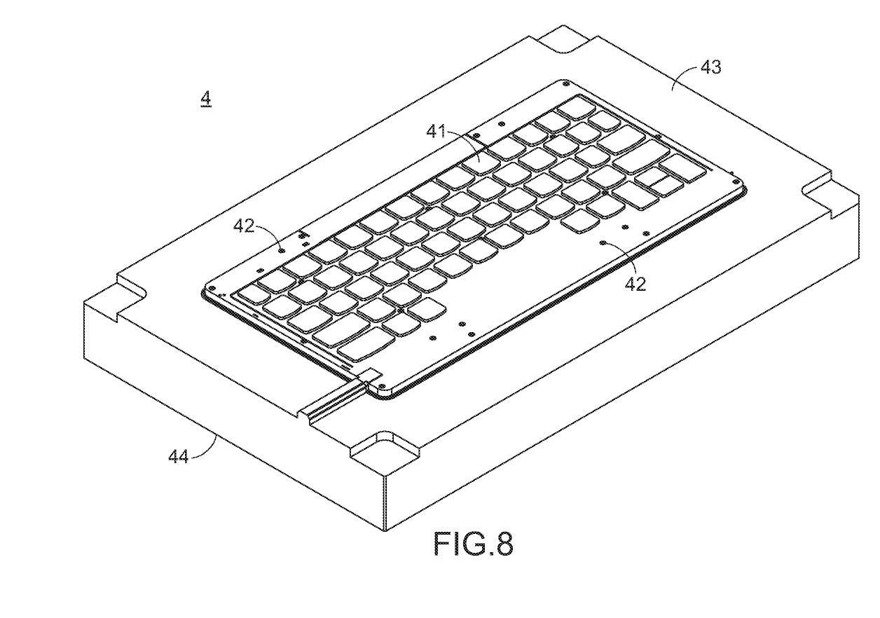

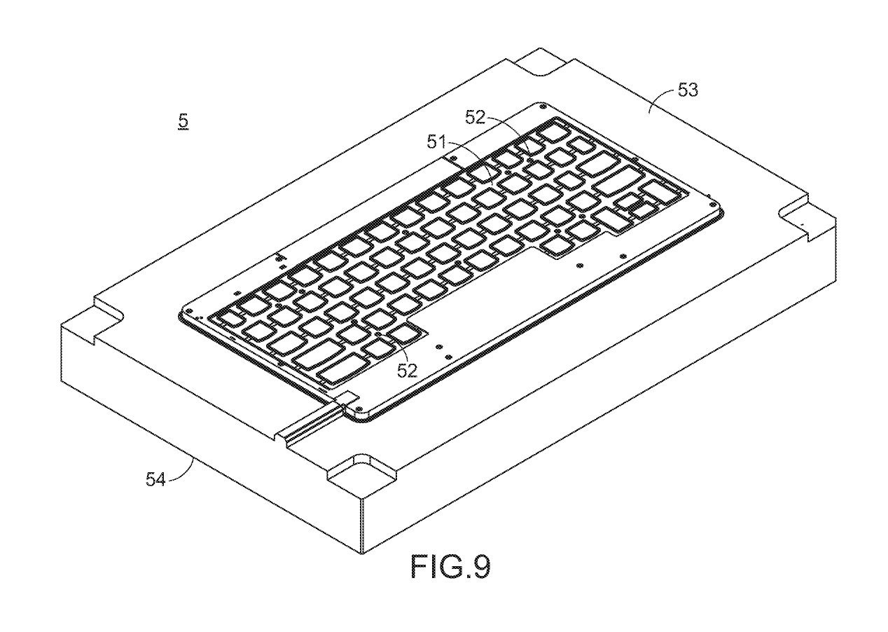

Hereinafter, the configuration of the molds for fabricating an integral structure of the upper cover 20 and the elastic key plate 21 will be illustrated with reference to FIGS. 7, 8 and 9. FIG. 7 is a schematic perspective view illustrating the outer appearance of a male mold for fabricating the keyboard device according to the first embodiment of the present invention. FIG. 8 is a schematic perspective view illustrating the outer appearance of a first female mold for fabricating the keyboard device according to the first embodiment of the present invention. FIG. 9 is a schematic perspective view illustrating the outer appearance of a second female mold for fabricating the keyboard device according to the first embodiment of the present invention.

Firstly, as shown in FIG. 7, a male mold 3 is provided. The male mold 3 comprises a core insert 31. The core insert 31 is formed in an inner surface 32 of the male mold 3. The core insert 31 is a concave structure with a shape matching the profile of the upper cover 20. The bottom of the concave structure has the shape complementary to the top surfaces of the plural elastic keys 211.

Then, as shown in FIG. 8, a first female mold 4 is provided. The first female mold 4 comprises a first cavity insert 41 and plural first charging holes 42. The first cavity insert 41 is disposed on an inner surface 43 of the first female mold 4. When the first female mold 4 and the male mold 3 are combined together, a first space (not shown) is formed between the first cavity insert 41 and the core insert 31. The first space is used for defining the upper cover 20. The first cavity insert 41 is a convex structure with a shape matching the profiles of the inner surface 203 of the upper cover 20 and the openings 201 of the upper cover 20. The plural first charging holes 42 run through the inner surface 43 of the first female mold 4 and an outer surface 44 of the first cavity insert 41. In addition, the plural first charging holes 42 are exposed outside the first cavity insert 41. After a first material is charged from the outer surface 44 of the first cavity insert 41, the first material flows into the first space through the plural first charging holes 42.

That is, after the male mold 3 and the first female mold 4 are combined together, the first space is formed between the core insert 31 and the first cavity insert 41. Moreover, the first material is charged into the first space through the plural first charging holes 42. Consequently, the profile of the upper cover 21 is defined by the structures of the core insert 31 and the first cavity insert 41.

Then, as shown in FIG. 9, a second female mold 5 is provided. The second female mold 5 comprises a second cavity insert 51 and plural second charging holes 52. The second cavity insert 51 is disposed on an inner surface 53 of the second female mold 5. When the second cavity insert 51 and the male mold 3 are combined together, a second space (not shown) is formed between the second cavity insert 51 and the core insert 31. The second space is used for defining the elastic key plate 21. The second cavity insert 51 is a convex structure with a shape complementary to a bottom surface 2121 of the plate body 21. The plural second charging holes 52 run through the inner surface 53 of the second female mold 5 and an outer surface 54 of the second cavity insert 51. In addition, the plural second charging holes 52 are exposed outside the second cavity insert 51. After a second material is charged from the outer surface 54 of the second cavity insert 51, the second material flows into the second space through the plural second charging holes 52.

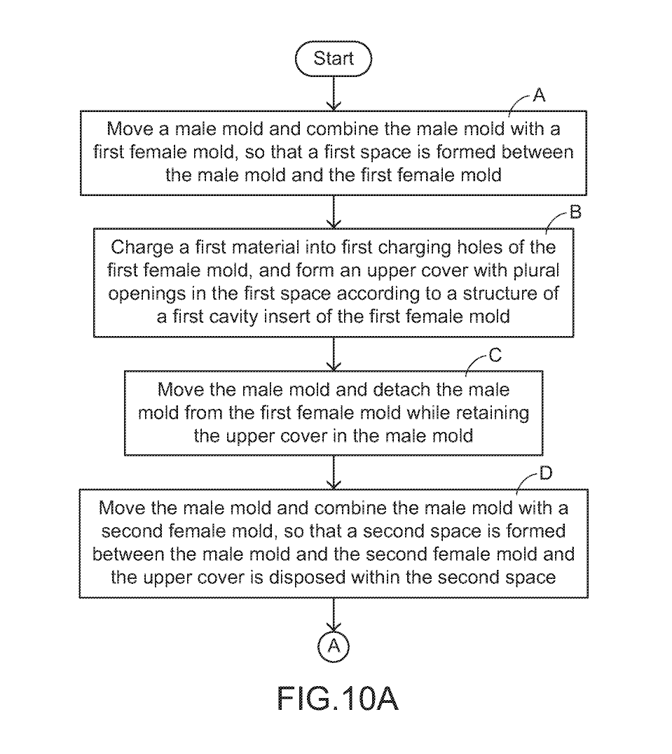

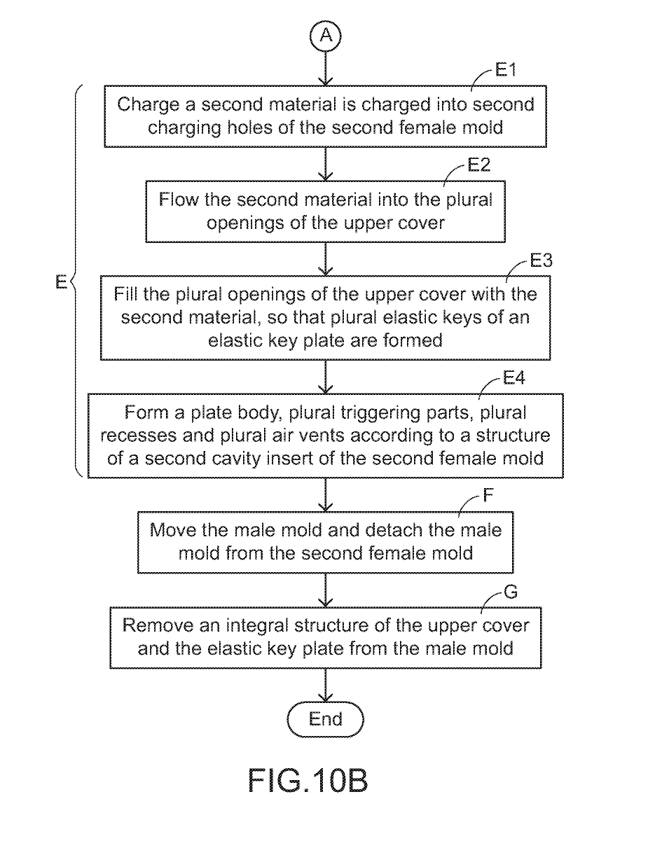

The key fabricating method for the keyboard device of the present invention will be illustrated as follows. FIGS. 10A and 10B are flowcharts illustrating a key fabricating method for the keyboard device according to the first embodiment of the present invention. The key fabricating method comprises the following steps.

In a step A, a male mold is moved and combined with a first female mold, so that a first space is formed between the male mold and the first female mold. In a step B, a first material is charged into first charging holes of the first female mold, and an upper cover with plural openings is formed in the first space according to a structure of a first cavity insert of the first female mold. In a step C, the male mold is moved and detached from the first female mold, and the upper cover is retained in the male mold. In a step D, the male mold is moved and combined with a second female mold, so that a second space is formed between the male mold and the second female mold and the upper cover is disposed within the second space. In a step E1, a second material is charged into second charging holes of the second female mold. In a step E2, the second material flows into the plural openings of the upper cover. In a step E3, the plural openings of the upper cover are filled with the second material, so that plural elastic keys of an elastic key plate are formed. In a step E4, a plate body, plural triggering parts, plural recesses and plural air vents of the elastic key plate are formed according to a structure of a second cavity insert of the second female mold. In a step F, the male mold is moved and detached from the second female mold. In a step G, an integral structure of the upper cover and the elastic key plate is removed from the male mold.

Moreover, the steps E1, E2, E3 and E4 may be collaboratively referred as a step E.

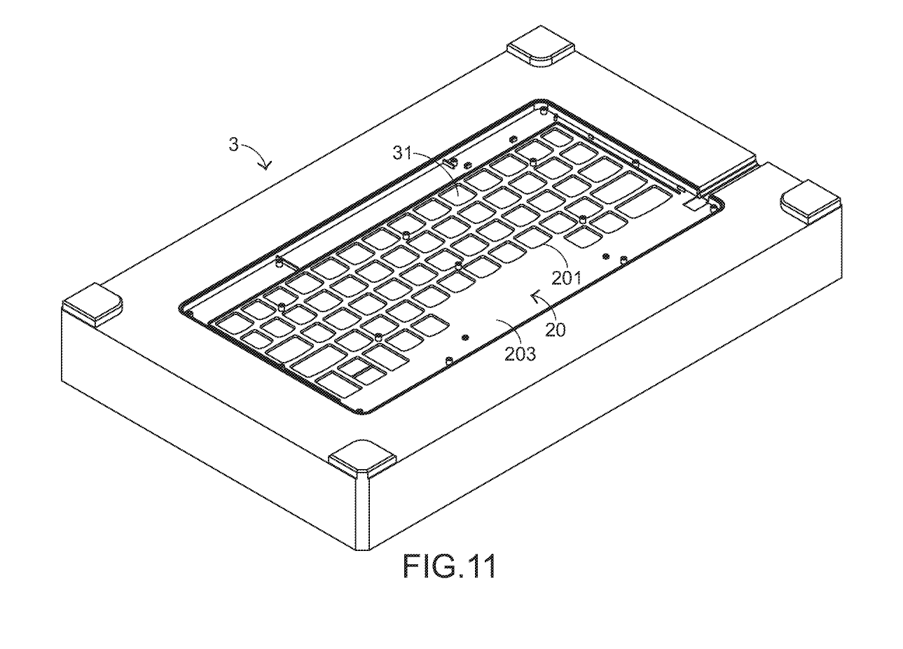

Firstly, in the step A, the male mold 3 is moved and combined with the first female mold 4, so that the first space is formed between the male mold 3 and the first female mold 4. Then, in the step B, the first material is charged into the plural first charging holes 42, and the first material flows to the first space. After a certain time period, the upper cover 20 is formed in the first space according to the shapes of the core insert 31 and the first cavity insert 41, wherein the upper cover 20 comprises the plural openings 201. In this embodiment, the first material is polycarbonate (PC) or acrylonitrile butadiene styrene (ABS). In the step C, the male mold 3 is moved and detached from the first female mold 4, and the upper cover 20 is retained in the core insert 31 of the male mold 3 (see FIG. 11).

Then, in the step D, the male mold 3 is moved and combined with the second female mold 5, so that a second space is formed between the male mold 3 and the second female mold 5, wherein the upper cover 20 is disposed within the second space. In the step E1, the second material is charged into the plural second charging holes 52. Then, in the step E2, the second material flows into the plural openings 201 of the upper cover 20. After a certain time period, the plural openings 201 of the upper cover 20 are filled with the second material, so that the plural elastic keys 21 of the elastic key plate 21 are formed (Step E3). After a certain time period, the second space is filled with the second material, and the plate body 212, the plural triggering parts 213, the plural recesses 214 and the plural air vents 215 are formed according to the structure of the second cavity insert 51 of the second female mold 5. In this embodiment, the second material is thermoplastic elastomer (TPE).

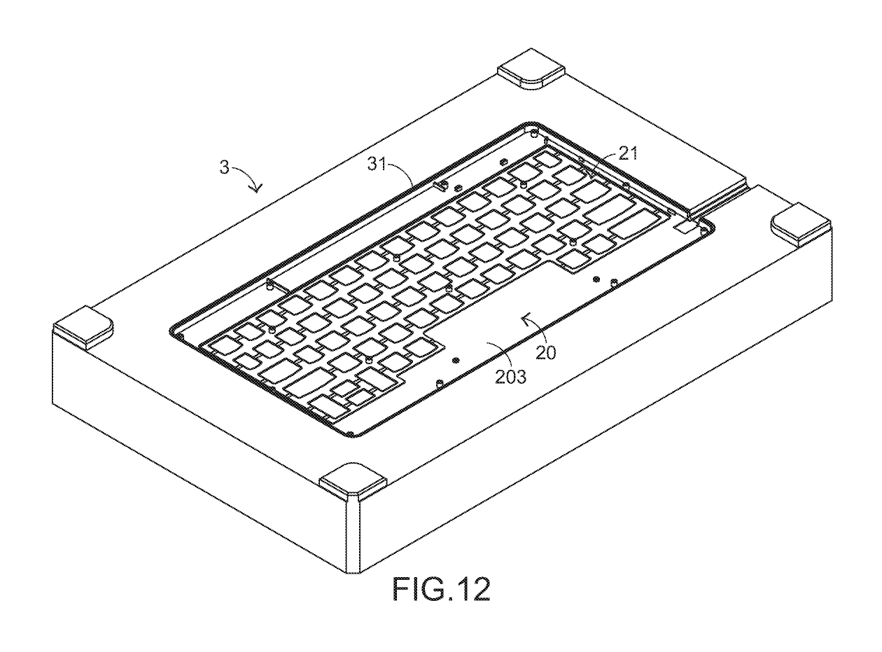

In the step F, the male mold 3 is moved and detached from the second female mold 5. Meanwhile, the integral structure of the upper cover 20 and the elastic key plate 21 is formed in the core insert 31 of the male mold 3 (see FIG. 12). Afterwards, in the step G the integral structure of the upper cover 20 and the elastic key plate 21 is removed from the male mold, and the key fabricating method of the present invention is completed. The subsequent procedures of assembling the integral structure of the upper cover 20 and the elastic key plate 21, the switch module 22, the base plate 23, the rechargeable battery 24, the connecting port 25, the inner wiring part 26 and the touch module 27 are well known to those skilled in the art, and are not redundantly described herein.

From the above discussions, the key fabricating method of the present invention uses a double-colored injection process to produce the integral structure of the upper cover 20 and the elastic key plate 21. After the integral structure of the upper cover 20 and the elastic key plate 21 is produced, the integral structure of the upper cover 20 and the elastic key plate 21 and other components are assembled. Consequently, the keyboard device 2 of the present invention is produced.

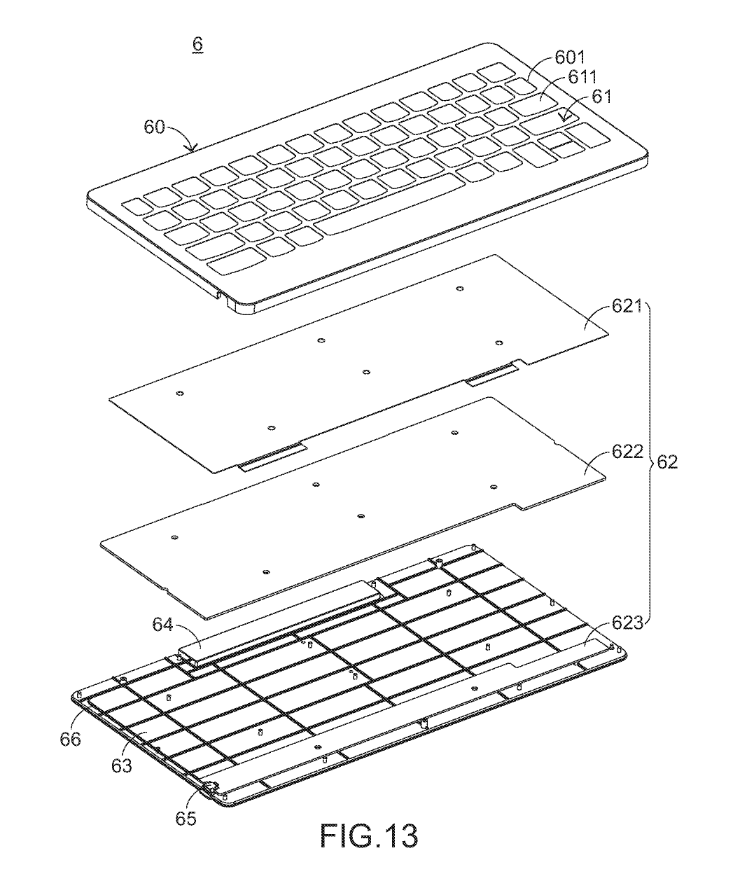

The present invention further provides a second embodiment. FIG. 13 is a schematic exploded view illustrating a keyboard device according to a second embodiment of the present invention. As shown in FIG. 13, the keyboard device 6 comprises an upper cover 60, an elastic key plate 61, a switch module 62, a base plate 63, a rechargeable battery 64, a connecting port 65, and an inner wiring part 66. The switch module 62 is disposed under the elastic key plate 61. When the switch module 62 is triggered by the elastic key plate 61, a corresponding key signal is generated. The switch module 62 comprises a membrane switch circuit member 621, a supporting plate 622, and a circuit board 623. In comparison with the keyboard device 2 of the first embodiment, the keyboard device 6 of this embodiment does not have the touch module and the function of moving the cursor. The structures and operating principles of the other components of the keyboard device 6 of this embodiment are similar to those of the keyboard device 2 of the first embodiment, and are not redundantly described herein.

Optionally, the keyboard device of the present invention may be additionally equipped with a light emitting diode and a light guide plate, and the elastic key may be equipped with a light-outputting region (e.g. a character region). Under this circumstance, the keyboard device of the present invention has an illuminating function.

From the above descriptions, the key fabricating method of the present invention uses the double-colored injection process to produce the integral structure of the upper cover and the elastic key plate of the keyboard device of the present invention. Consequently, there are no gaps between the plural elastic keys and the plural openings of the upper cover. Under this circumstance, since the dust or the foreign liquid cannot be introduced into the inner portion of the keyboard device, the inner circuitries of the keyboard device will not be damaged by the dust or the foreign liquid. Moreover, since the elastic key plate and the upper cover are integrally formed with each other, it is difficult to detach the elastic keys from the keyboard device. In other words, the design of the keyboard device of the present invention can prevent the detached keys from being eaten by children or babies. On the other hand, since the elastic key is elastic and deformable, the scissors-type connecting elements and the elastic elements of the conventional keyboard device are no longer included in the keyboard device of the present invention. Consequently, the number of parts is reduced, the reliability is enhanced, and the material cost is reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device, comprising:
an upper cover comprising plural openings;
an elastic key plate disposed on an inner surface of the upper cover, wherein the elastic key plate comprises plural elastic keys, and the plural elastic keys are inserted into the plural openings of the upper cover and exposed outside the upper cover, wherein the elastic key plate is integrally formed with the upper cover, and there are no gaps between the plural elastic keys and the openings of the upper cover;
a switch module disposed under the elastic key plate, wherein when the switch module is triggered by one of the plural elastic keys, the switch module generates a corresponding key signal; and
a base plate disposed under the switch module and supporting the switch module.

2. The keyboard device according to claim 1, wherein the elastic key plate further comprises:
a plate body, wherein the plural elastic keys are supported by the plate body;
plural triggering parts disposed on bottom surfaces of the plural elastic keys, respectively, wherein when one of the plural elastic keys is depressed, the corresponding triggering part is subject to deformation so as to trigger the membrane switch circuit member;
plural recesses arranged between the plate body and the plural triggering parts, wherein the plural triggering parts are separated from each other by the plural recesses, wherein through the plural recesses, the triggering parts adjacent to a specified triggering part are not driven by the specified triggering part; and
plural air vents formed in a bottom surface of the plate body, and located beside the plural elastic keys, wherein when the switch module is triggered by the plural elastic keys, air is vented through the corresponding air vents, so that the plural elastic keys are not adsorbed by the switch module, wherein the plural elastic keys and the plural triggering parts are integrally formed with the plate body.

3. The keyboard device according to claim 2, wherein the switch module comprises:
a membrane switch circuit member disposed under the plural elastic keys and not contacted with the elastic key plate, wherein when the membrane switch circuit member is triggered by the one of the plural elastic keys, the membrane switch circuit member generates the corresponding key signal;
a supporting plate arranged between the membrane switch circuit member and the base plate, wherein the membrane switch circuit member is supported by the supporting plate, so that the membrane switch circuit member is kept flat; and
a circuit board connected with the membrane switch circuit member, wherein the key signal is outputted from the circuit board,
wherein when the one of the plural elastic keys is depressed, the corresponding elastic key and the corresponding triggering part are subject to deformation and contacted with the membrane switch circuit member, so that the key signal is generated.

4. The keyboard device according to claim 3, further comprising a touch module, wherein the touch module is disposed on the circuit board and connected with the circuit board, wherein the touch module detects a motion of a user's finger, and generates a displacement signal corresponding to the motion of the user's finger.

5. The keyboard device according to claim 1, further comprising:
a rechargeable battery disposed on the base plate and connected with the switch module, wherein the rechargeable battery provides electric power to the switch module; and
a connecting port fixed on the switch module and connected with the rechargeable battery, wherein a power source is connected with the connecting port through an external wire so as to charge the rechargeable battery.

6. A key fabricating method for a keyboard device, the key fabricating method comprising steps of:
combining a male mold with a first female mold to define a first space between the male mold and the first female mold;
charging a first material into a first charging hole of the first female mold to form an upper cover in the first space;
detaching the male mold from the first female mold and retaining the upper cover in the male mold;
combining the male mold with a second female mold to define a second space between the male mold and the second female mold and dispose the upper cover within the second space; and
charging a second material into a second charging hole of the second female mold to form an integral structure of the upper cover and an elastic key plate in the second space and form plural elastic keys on the elastic key plate.

7. The key fabricating method according to claim 6, wherein in the step of charging the first material into the first charging hole of the first female mold to form the upper cover in the first space, plural openings of the upper cover are further formed according to a structure of a first cavity insert of the first female mold.

8. The key fabricating method according to claim 7, wherein the step of charging the second material into the second charging hole of the second female mold to form the integral structure of the upper cover and the elastic key plate in the second space and form the plural elastic keys on the elastic key plate comprises sub-steps of:
flowing the second material into the plural openings of the upper cove;
filling the plural openings of the upper cover with the second material, so that the plural elastic keys of the elastic key plate are formed; and
forming plural triggering parts, plural recesses and plural air vents of the elastic key plate according to a structure of a second cavity insert of the second female mold.

9. The key fabricating method according to claim 6, wherein in the step of combining the male mold with the first female mold to define the first space between the male mold and the first female mold, the male mold is moved toward the first female mold, so that the male mold is combined with the first female mold, wherein in the step of detaching the male mold from the first female mold and retaining the upper cover in the male mold, the male mold is moved away from the first female mold, so that the male mold is detached from the first female mold, wherein in the step of combining the male mold with the second female mold to define the second space between the male mold and the second female mold and dispose the upper cover within the second space, the male mold is moved toward the second female mold, so that the male mold is combined with the second female mold.

10. The key fabricating method according to claim 6, wherein after the step of charging the second material into the second charging hole of the second female mold to form the integral structure of the upper cover and the elastic key plate in the second space and form plural the elastic keys on the elastic key plate, the key fabricating method further comprises steps of:
moving the male mold and detaching the male mold from the second female mold; and
removing the integral structure of the upper cover and the elastic key plate from the male mold.
